(19) United States
(12) Patent Application Publication
(10) Pub. No.: US 2024/0309654 A1
(43) Pub. Date: Sep. 19, 2024

(54) METHOD AND SYSTEM FOR CURING A COATING LAYER OF A DECORATIVE FLOOR PANEL OR WALL PANEL

(71) Applicant: Champion Link International Corporation, The Valley (AI)

(72) Inventors: Thomas Luc Martine BAERT, Sint-Martens-Latem (BE); Tom VAN POYER, Jiaxing (CN); Sven BOON, Jiaxing (CN)

(73) Assignee: Champion Link International Corporation, The Valley (AI)

(21) Appl. No.: 18/675,951

(22) Filed: May 28, 2024

Related U.S. Application Data
(63) Continuation-in-part of application No. 18/324,519, filed on May 26, 2023.

(30) Foreign Application Priority Data
Jan. 31, 2023 (NL) 2034059

(51) Int. Cl. E04F 15/10; C09D 5/00; C09D 133/04; C09D 175/04; E04F 13/08

(52) U.S. Cl. CPC E04F 15/107; C09D 5/002; C09D 133/04; C09D 175/04; E04F 13/0866

(57) ABSTRACT

The invention relates to a decorative floor panel or wall panel with at least one core layer; at least one decorative surface comprising at least one decorative print; and at least one coating layer provided upon the decorative surface. The at least one coating layer comprises at least one primer layer and at least one top coating layer. The at least one top coating layer comprises at most 0.5 wt % of matting agents, wherein the gloss or sheen level of the at least one top coating layer is at most 4 Gu. The panel comprises a texture on the top surface with the texture comprising a plurality of cavities or recesses forming a first and second surface area, and the first surface area and/or the second surface area have a gloss level difference of less than 10 Gu. The sum of the first and second surface area forms the top surface area.

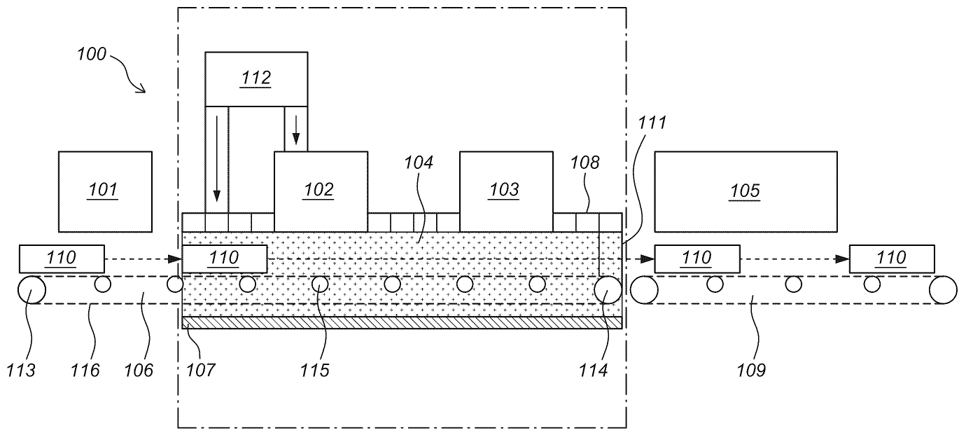

### CROSS REFERENCE TO RELATED APPLICATIONS

This application is a continuation-in-part application under 35 U.S.C. § 120 of U.S. Ser. No. 18/324,519, filed May 26, 2023, which claims priority under 35 U.S.C. § 119 to Netherland Patent Application No. NL 2034059 filed on Jan. 31, 2023. The contents of both prior applications are hereby incorporated herein by reference in their entirety.

### FIELD OF THE INVENTION

The invention relates to a method for curing a coating layer of a decorative floor panel or wall panel. The invention also relates to a system for curing a coating layer of a decorative floor panel or wall panel.

### BACKGROUND

Ultraviolet (UV) coating and curing technology are extremely common in the manufacturing industry because of their advantages such as energy saving, high efficiency, low pollution, and rapid curing process. UV curing is a photochemical process that involves irradiating transparent UV curable coatings generally comprising acrylic monomers and oligomers as well as photo-initiators with UV rays which creates a cross-linking reaction that instantly or nearly instantly cures or dries the coating. This curing speed translates into a high productivity and low production costs. In addition to these advantages, UV curing is relatively environmentally friendly as it does not encourage the emission of volatile organic compounds as in other curing processes. UV curing also has become an important and necessary process to produce decorative floor and wall panels, in particular thermoplastic decorative panels.

Transparent UV cured coatings, when applied to floor or wall panels, enhance multiple surface properties, such as the surface wear resistance, scratch resistance in the case of flooring, or stain resistance and glossiness in the case of wall panels.

The application of a UV coating also allows to control the gloss and reflectivity of the surface of floor panels. However, there are also drawbacks to this technology. First, it is very difficult to achieve a low reflectivity or matte surface through these conventional means. Conventional methods include application or embedding of matting agent, generally inorganic or ceramic particles (Al2O3, SiO2, TiO2 and the like), in the coating. Matting agents with a particle size similar to or smaller than the thickness of the coating layer are commonly used. However, this method causes difficulties in production due to sedimentation of the matting agent, and more importantly, the resulting embedded particles are easily removed from the surface by friction during regular use as a floor panel, or even during production, causing unwanted glossy spots and increased defect and waste rates. It can be assumed that the gloss level of a flooring surface and slip resistance deteriorate during use due to the abrading of the microstructure or surface roughness of the surface and the dislodging of the inorganic particles embedded on the surface of the flooring finish, such as abrasive, antibacterial and matting particles. Another conventional method used to overcome said drawbacks on achieving a matting surface is the introduction of volatile components to increase the shrinkage degree of at least part of the coating layer during curing process. However, this method increases the emission of volatile compounds, which is not desirable for health and environmental reasons.

Another drawback of UV curing technology is that the efficiency and effectiveness of UV curing systems are highly dependent on the radiation intensity of the lamp used and the overall curing power from the UV source. However, with high radiation intensity and high operating temperatures, lamps are prone to faster decay and reflectors can warp and wrinkle due to thermal expansion. As a result, there is an increased risk of devitrification/clouding in which UV radiation can no longer pass through the quartz wall in UV lamps because the quartz has converted back into a crystalline structure due to the UV lamp becoming too hot. In addition, deformed reflectors tend to scatter or diffuse the light ray pattern that is being reflected to a subject being cured. With UV light falling below full intensity and not being able to completely pass through the quartz wall, the overall ability of the UV curing system to reach the necessary levels required for curing UV coatings is greatly decreased. Hence, there is a desire to develop a method and system for UV curing that takes away at least one of the drawbacks of the current UV curing systems, or least to provide an alternative.

Recent development focusses on short wavelength UV curing processes. The resulting UV cured decorative floor panels however have an insufficiently rough surface texture (surface roughness Rz of less than 10 μm) and an unqualified slip resistance when tested as specified in EN 14041 with a COF of less than 0.35 and a P-rating of less than P4, generally less than P3. Furthermore, due to the nature of the production process, deeper surface textures imitating wood and/or stone texture are limited to a maximum depth of 0.1 mm.

Further, the heat that this short wavelength UV radiation creates, causes the surface of the floor panel to be heated up to 90 to 100 degrees Celsius. As resilient flooring panels are composed of thermoplastics, at these temperatures these panels or boards show deformation, shrinking, and generally become uneven in flatness. As the production process of short wavelength UV necessitates the use of an inert chamber, this unevenness causes oxygen contamination in the inert environment, which impacts the ability to speed up production, as well as the product quality.

It is therefore an object of the invention to provide a system and method for curing a coating layer of resilient decorative building panels, such as wall and/or floor panels, that is preferably specifically designed for high-speed production and which benefits over the conventional systems and methods.

The invention provides thereto a method for curing a coating layer of a decorative floor panel or wall panel, comprising the steps of:
providing at least one panel, in particular a floor panel or wall panel, said panel comprising at least one core layer and at least one decorative surface;
providing at least one coating layer, in particular an uncured coating layer, upon at least part of the decorative surface of the panel;
subjecting at least part of the coating layer to a first irradiation step for a first time period at a first wavelength;
subjecting at least part of the coating layer to a second irradiation step for a second time period at a second wavelength;
   wherein the first irradiation step and the second irradiation step are performed in an inert environment.

### BRIEF DESCRIPTION OF THE FIGURES

The FIGURE illustrates a system according to one embodiment of the present invention.

### DETAILED DESCRIPTION

The method according to the present invention enables high intensity curing in an efficient manner wherein a high quality product can be obtained. Due to at least part of the preferably at least partially uncured coating layer being subjected to a first irradiation step for a first time period at a first wavelength and subsequently to a second irradiation step for a second time period at a second wavelength, which both irradiation steps are performed in an inert environment, a substantially fully cured coating layer having desirable material properties can be obtained in an effective manner. A panel obtained by applying the method according to the invention has a sufficiently rough surface texture, in particular a surface roughness Rz larger than 10 μm, and a qualified slip resistance when tested as specified in EN 14041. A non-limiting example of such panel has a coefficient of friction (COF) of more than 0.35 and a P-rating of more than P4, generally at least P3. The method enables that no matting agents needs to be incorporated in the coating layer in order to obtain the desired gloss level. Another benefit is that no volatile compounds are needed to ensure sufficient curing of the coating layer or achieve a desired matte effect. Overall, the curing process is more energy efficient compared to conventional methods which apply high radiation intensity and high operating temperatures.

The panel as applied is in particular a floor panel or wall panel and comprises at least one core layer and at least one decorative surface. The decorative surface can for example be the upper surface of the core layer. The decorative surface could for example comprise a decorative print, in particular a decorative digital print. It is also conceivable that the decorative surface is separate decorative (top) layer. Such decorative top layer could be directly or indirectly attached to the core layer.

At least one coating layer as applied in the method according to the present invention typically consists of a coating composition. Hence the step wherein at least one coating layer is provided, in particular an uncured coating layer, upon at least part of the decorative surface of the panel could also be referred to as a step wherein a coating composition is provided such that at least one coating layer is formed, in particular at least one uncured coating layer, upon at least part of the decorative surface of the panel. The coating composition is preferably an uncured coating composition upon application. The at least one coating layer is in particular a UV curable coating layer. It is conceivable that at least one, more preferably at least two coating layers are applied at least partially on at least the top surface and/or decorative surface of the panel. The bottommost coating layer can also be called a priming layer. It is also conceivable that the at least one priming layer is applied prior to the provision of at least one further coating layer. The topmost layer can be called a topmost coating layer or top coating. The entirety of n coating layers, most preferably comprising at least one primer and/or at least one top coating, can be called a finish.

The method according to the present invention could also be described as a method for curing at least one coating layer, top coating layer or finish of a decorative floor panel or wall panel, comprising the steps of providing at least one panel, in particular a floor panel or wall panel, said panel comprising at least one core layer and at least one decorative surface, providing at least one coating layer, in particular an uncured coating layer, upon at least part of the decorative surface of the panel, positioning the panel in an inert environment, subjecting at least part of the coating layer to a first irradiation step for a first time period at a first wavelength, subjecting at least part of the coating layer to a second irradiation step for a second time period at a second wavelength and removing the panel from the inert environment.

The first irradiation step and the second irradiation step are in particular subsequent steps performed in the same inert environment. In this way, the overall curing process can be optimized and curing can be efficiently incorporated in a (high speed) production line. When it is referred to an inert environment, for example an inert chamber can be meant. A single inert chamber can be configured to perform at least two separate irradiation steps, preferably in a sequential manner.

At least one coating layer preferably comprises at least one acrylic monomer and/or at least one oligomer. At least one acrylic monomer and/or at least one oligomer could form the basis component of the coating layer. However, it is for example also possible that at least one acrylic monomer and/or at least one oligomer are incorporated in the coating layer as an additive. Non-limiting examples of monomers which could be applied in the context of the present invention are a crosslinking acrylate monomer, a polymerizable cyclic/aromatic acrylate monomer and/or a diluent acrylate monomer. At least one oligomer, if applied, could for example be a crosslinkable oligomer. Non-limiting examples of crosslinkable oligomers which could be applied are an acrylic oligomer and/or a polyurethane oligomer.

In a preferred embodiment, at least one coating layer comprises at least one photo-initiator. The at least one first photo-initiator is configured to react to the irradiation steps, preferably such that the photo-initiator decomposes thereby leading to the formation of radical or cation active species, which would initiate the active monomers and/or oligomers in the coating layer. At least one photo-initiator could for example decompose into free radicals when exposed to radiation, in particular UV radiation, to initiate crosslinking of the coating layer. At least one photo-initiator can for example be a radical photo-initiator and/or cationic photo-initiator. At least one photo-initiator preferably comprises acrylate- or styrene-based formulations, methyl-2-benzoylbenzoate, 2-hydroxy-2-methyl-1-phenyl-1 propanone, benzyl dimethyl ketal, 1-hydroxy-cyclohexylphenyl-ketone, or methyl benzoyl formate, or other photo-initiator, or any combination thereof. At least one photo-initiator is preferably configured to react to light or ultraviolet (UV) light having a wavelength in the range of 108 to 395 nm. It is conceivable that at least one photo-initiator, most preferably the photo-initiator present in the top coating, is configured to react to light or ultraviolet (UV) light having a wavelength in the range of 108 to 250 nm, more in particular in the range of 160 to 180 nm. Most preferably the photo-initiator present in the top coating is configured to react to ultraviolet light having a wavelength of 172 nm.

In a further preferred embodiment, at least one coating layer comprises in the range of 2 wt % to 10 wt % of at least one photo-initiator, in particular based on total weight of the coating formulation. More specifically, at least one coating layer comprises in the range of 2 wt % to 5 wt % of at least one photo-initiator, in particular based on total weight of the coating formulation. More preferably, at least one coating layer comprises about 3 wt % of at least one photo-initiator, in particular based on total weight of the coating formulation.

The viscosity of the uncured coating layer, upon application, is preferably in the range of 96 to 683 centistokes (cSt) and/or 35-45 seconds measured using a DIN viscosity flow cup 4. The viscosity of the coating layer is preferably smaller than 5000 Pa·s at 25 degrees Celsius, more preferably between 500 and 3000 Pa·s at 25 degrees Celsius and even more preferably between 800 and 1500 Pa·s at 25 degrees Celsius, in an uncured condition. The viscosity is of relevance since a correct viscosity range can avoid flooding of the panel surface texture, for example in case the panel or the decorative surface thereof comprises a texture to imitate a wood or stone grain, and splatter of the coating at higher production speeds. A too high viscosity however would not achieve a complete enough transfer onto the board surface and lead to incomplete coating.

At least one coating layer can be configured to provide protection to the topmost portion of the panel. At least one coating layer preferably comprises at least one thermoplastic resin and/or at least one thermosetting resin. Non-limiting examples of thermoplastic resins or thermosetting resins which could be used are polyvinyl chloride (PVC), polystyrene (PS), polyethylene (PE), polyurethane (PU), acrylonitrile butadiene styrene (ABS), polypropylene (PP), polyethylene terephthalate (PET), phenolic and/or melamine or formaldehyde resins. In a preferred embodiment, the coating layer can for example be a polyurethane coating, an acrylic coating, and/or an epoxy polyol coating. According to another embodiment of the present invention, the at least one coating layer may further comprise abrasion resistant materials in order to improve the wear resistance thereof. Non-limiting examples of said abrasive materials are: aluminium oxide, quartz, silica, silicon dioxide, titanium dioxide, corundum, carborundum, silicon carbide, glass, glass beads, glass spheres, diamond particles, hard plastics, reinforced polymers and organics, combination thereof, or other alternative particles with a high Mohs hardness such as diamond particles, and the like.

In a further embodiment, the at least one coating layer further comprises antimicrobial, antiviral (si-quat), antibacterial and/or anti-fungus agents. As such, the coating layer may further comprise an antimicrobial agent that can be incorporated therein before the curing step. The antimicrobial agent embedded in the coating layer, if applied, is conceived to be able to inhibit the emergence and/or growth of microbes such as fungus, bacteria (i.e. gram positive and gram-negative bacteria such as Staphylococcus aureus, Kleibsella pneumoniae and Salmonella and the like), yeast and other pathogens including nonpathogens on the surface of the floor panel. It is conceivable that the antimicrobial agent may be organic or inorganic, preferably non-toxic and without heavy metals. The antimicrobial agent may be selected from the group consisting of quaternary ammonium compounds, sesquiterpene alcohols, halogenated phenyl ethers, halogenated carbanilides, halogenated salicylanilides, bisphenolic compounds, general phenols, formaldehyde, pyridine derivatives and hexachlorophene. The aforementioned antimicrobial agents are preferred over disinfectants such as iodine and complexes thereof as these are highly pigmented and may cause detrimental effects to the chemical, mechanical and physical properties of the coating layer, specially to the transparency/clarity of the coating layer which is desired in order to conserve the aesthetics of the panel. The antimicrobial agent, if applied, is preferably present in the coating layer 300 from about 0.05% to about 5% by weight, preferably from about 0.070% to about 3.5%, more preferably from about 0.080% to about 3%. It is experimentally found that said amount of antimicrobial agent in the coating layer is able to survive crosslinking/polymerization during the curing process, or in other words is not destroyed during curing, without causing undesirable effects to the chemical, mechanical and physical properties of the coating layer. Said amount of antimicrobial agent in the coating layer is also experimentally found to last the lifetime of the coating layer while also being sufficient to inhibit the formation and/or growth of microbes. The coating layer, in particular the upper coating surface of the coating layer, preferably has a Shore D hardness of at least 85 or preferably be in the range of 90 to 95.

The substrate and in particular the core layer may comprise a composite material. The core layer may for example comprise at least one filler and at least one binder. The binder can be selected from, but is not limited to, thermoplastic or thermoset resins including but not limited to vinyl, polyvinyl chloride (PVC), polyethylene (PE), polyurethane (PU), acrylonitrile butadiene styrene (ABS), melamine, and/or polypropylene (PP). Preferably, the ratio of weight percentages of filler relative to binder is at least 1:1, more preferably at least 2:1, most preferably at least 3:1. The filler material used in the core layer can comprise organic and/or inorganic materials. Such organic and inorganic materials include but are not limited to cellulose materials, fibrous materials, kraft paper, saw dusts, wood dusts, wood fibers, long wood fibers, short wood fibers, sand, lime, volcanic ash, plants-based fibers such as mushroom fibers, cotton fibers, bamboo fibers, abaca fibers, pineapple fibers, magnesium compounds, magnesium oxide, magnesium carbonate, limestone, polymeric fibers, glass fibers, carbon-based fibers, polymeric pellets, or hollow microspheres or particles having size ranging from 1 to 1000 micrometers made of but is not limited to ceramics, glass, polymers, composites, or metals. Preferably, the core layer includes at least one filler selected from the group consisting of: minerals, preferably calcium carbonate; and pigments, modifiers, fibers, such as: glass fiber, wood, straw and/or hemp. The fibers can be loose fibers and/or interconnected fibers to form a woven or nonwoven layer. Preferably the core layer further includes at least one additional filler selected from the group consisting of steel, glass, polypropylene, wood, acrylic, alumina, curaua, carbon, cellulose, coconut, kevlar, Nylon, perlon, polyethylene, PVA, rock wool, viburnum and fique. This can further increase the strength of the panel itself and/or the water resistance and/or fire resistance of the panel.

It is conceivable that at least one core layer comprises a composite material, in particular a mineral composite material, more in particular a mineral thermoplastic composite. The core layer may for example comprise a magnesium oxide or MgO-based composite. The core layer may for example comprise MgCl2 and/or MgSO4. The composite core layer may for example comprise at least 20% by weight of magnesium oxide. A non-limiting example of a possible composite core layer, is a core layer comprising 30 to 40% by weight magnesium oxide, 10 to 20% by weight magnesium chloride or magnesium sulfate, 10 to 15% by weight water, 5 to 10% by weight magnesium hydroxide, 5 to 10% by weight calcium carbonate, 5 to 50% by weight lignocellulose (e.g. wood fibers or cork) and/or 10-15% by weight additives. It is found that a composite core layer, in particular a mineral composite core layer, has a good stability to heat which is also beneficial for the panel as such. The density of at least one core layer is preferably between 1200 and 2000 kg/m3, more preferably between 1400 and 1600 kg/m3. However, it is also conceivable that the density of at least one core layer is about 2000 kg/m3. The latter is for example possible when the core layer comprises a thermoplastic mineral composite. The mineral material can be selected from the group of magnesium oxide, magnesium carbonate, magnesium oxysulfate, magnesium oxychloride cement (MOC), magnesium chloride (MgCl2), magnesium sulfate (MgSO4), Sorel cement, fiber cement, MOS cement, limestone, calcium carbonate, calcite mineral, stone, chalk, clay, calcium silicate and/or talc. In some embodiments, the mineral material is preferably present as particulate mineral filler of at least 200 mesh, preferably more than 300 mesh. The thermoplastic mineral composite core layer may for example comprise 60 to 70% by weight of calcium carbonate, 20 to 25% by weight of polyvinyl chloride and possibly 5 to 10% by weight of additives. At least one core layer may comprise a density gradient, for example wherein the density near the upper surface is higher than the density near the bottom surface, or wherein the density near the upper surface and the bottom surface is higher than the density of a central region situated between said upper surface and bottom surface. A further non-limiting example of a possible core layer is an HDF based core layer comprising cellulose and a thermosetting resin. It is also conceivable that the core layer is a wood-based core comprising cellulose and/or a geopolymer based on magnesium oxide. The panel and/or the core layer is preferably waterproof.

In a preferred embodiment the core layer may comprise at least one additive material, advantageously including surface active substances (surface active substances, SAS), such as methyl cellulose, “Badimol” plasticizing materials and other cationic active SAS, in particular configured to improve the rheology of the mixture. The core may also include bentonite.

Bentonite is a finely ground natural product suitable for increasing the rheological and waterproof properties of the panel itself. The core layer may also comprise a combination or composite of any of the materials previously mentioned. It is conceivable that the composite material comprises at least 20% by weight of filler and/or 15% to 50% by weight of a binder. This range is found to secure sufficient stability and strength of the core layer while also allowing for necessary flexibility thereof and improving temperature resistance as well. In at least some embodiments, it is beneficial to apply a substrate or core layer having a rigidity of at least 3500 MPa, in particular when measured according to EN310 or ASTM D790. The substrate and/or core layer may for example have a thickness of at least 4 mm. It is for example possible that the thickness of the core layer is between 3 and 8 mm, preferably between 4 mm and 5.5 mm or between 5.5 mm and 7 mm.

In another embodiment, rigidity is at most 3500 Mpa and/or pass at least 40 mm, most preferably pass 25.4 mm/1 inch according to the mandrel test ASTM F137 and/or ISO 24344, and/or the thickness of the core is at most 4.5 mm, more preferably at most 3.5 mm, most preferably at most 2 mm. It is conceivable that at least one core layer comprises at least one reinforcing layer. The reinforcing layer can for example be a reinforcing mesh. Possibly, the core comprises at least two reinforcing layers, wherein a first reinforcing layer is located near the upper surface and wherein a further reinforcing layer is located near the bottom surface. Preferably, at least one reinforcing layer comprises a mesh or web, preferably comprising fiberglass, jute and/or cotton.

The substrate, and in particular the core layer, may optionally comprise complementary coupling parts. The core could for example comprise at least one pair of opposite side edges which are provided with complementary coupling parts. The complementary coupling parts, if applied, are typically configured for interconnecting adjacent panels. Typically, at least one pair of opposite side edges of the core layer is provided with complementary coupling parts. For example, the core layer comprises at least one pair of complementary coupling parts on at least two of its opposite side edges. Said coupling parts may for example be interlocking coupling parts configured for mutual coupling of adjacent panels on multiple directions. Preferably, said interlocking coupling parts provide locking in both horizontal and vertical directions. Any suitable interlocking coupling parts as known in the art could be applied. For example, said interlocking coupling parts may be in the form of complementary tongue and groove, male and female receiving parts, a projecting strip and a recess configured to receive said strip or any other suitable form. It is conceivable the complementary coupling parts require a downward scissoring motion when engaging, or are locked together by means of a horizontal movement. It is further conceivable that the interconnecting coupling mechanism comprise a tongue and a groove wherein the tongue is provided on one side edge of one pair of opposite side edges, and the groove is provided on the other side edge, or an adjacent side relative to that of the tongue, of the same pair of opposite side edges. Such a design of coupling mechanism is well-known in the art and has proven highly suitable for panels for floor coverings such as a floating floor. In a further embodiment it is possible that the interconnecting coupling mechanism have an interlocking feature which prevents interconnected panels from any free movement (play). Such an interlocking feature may be a projection and a respective recess provided on the respective opposite side edges by which neighboring panels interlock with each other. It is conceivable for provisions of reinforcement in the interlocking coupling parts to improve strength and prevent breakage thereof during installation of the panels. For example, the complementary or interlocking coupling parts may be reinforced with materials such as but not limited to fiberglass mesh, reinforcing sheets, carbon fibers, carbon nanotubes, ceramics, glass, arrays of metallic or non-metallic rods, or polymer compounds integrally formed in the core layer. It is also conceivable that a strengthening coat layer of micro or nanotechnology is added on the surface of the interlocking coupling parts. The panel according to the present invention and/or the panel obtained via the method according to the present invention is suitable for use in flooring, wall or ceiling coverings preferably featuring a locking mechanism. As such a ‘floating’ covering can be assembled by interconnecting the individual panels with each other at all four sides, without the need for adhesives.

The panel may comprise at least one further layer, such as but not limited to a backing layer. The method according to the present invention may also include the step of providing and/or attaching at least one backing layer to the bottom surface of the core layer. In case a backing layer is applied, the backing layer can be adhered on the bottom surface of the substrate, and in particular of the core layer via an adhesive. The backing layer is preferably made of a polymer material, for example but not limited to polyurethane. The backing layer may also be a sound absorbing layer. Such sound absorbing backing layer may further contribute to the good acoustic properties of the panel. Such backing layer may also be referred to as an acoustic layer. The backing layer may be composed of a foamed layer, preferably a low-density foamed layer, of ethylene-vinyl acetate (EVA), irradiation-crosslinked polyethylene (IXPE), expanded polypropylene (XPP) and/or expanded polystyrene (XPS). However, it is also conceivable that the backing layer comprises nonwoven fibers such as natural fibers like hemp or cork, and/or recycled/recyclable material such as PET. The backing layer, if applied, preferably has a density between 65 kg/m3 and 300 kg/m3, most preferably between 80 kg/m3 and 150 kg/m3.

It is also conceivable that at least one decorative surface is a print layer, in particular a digital print layer. The decorative surface may also form integral part of the core layer. In a beneficial embodiment of the panel, at least part of the upper surface of the core layer is provided with at least one decorative pattern or decorative image. It is for example possible that such decorative image or pattern is provided via printing, for example via digital and/or inkjet printing. It is also possible that at least one decorative pattern is formed by relief provided in the upper surface of the core layer or panel. It is also conceivable that the decorative surface is a separate layer, for example a comprises a high-pressure laminate (HPL), a veneer layer and/or a ceramic tile. In a preferred embodiment, at least one decorative layer comprises a thermoplastic film or a ply of cellulose. It is for example possible that the décor layer comprises a plurality of impregnated layers containing lignocellulose but also a wood veneer, a thermoplastic layer, a stone veneer, a veneer layer or the like and/or a combination of said materials. The veneer layer is preferably selected from the group comprising of wood veneer, cork veneer, bamboo veneer, and the like. Other materials such as ceramic tiles or porcelain, a real stone veneer, a rubber veneer, a decorative plastic or vinyl, linoleum, and laminated decorative thermoplastic material in the form of foil or film. The thermoplastic material can be PP, PET, PVC and the like. The design of the decorative layer can be chosen from a design database which includes digitally processed designs, traditional patterns, pictures or image files, customized digital artworks, randomized image pattern, abstract art, wood-patterned images, ceramic or concrete style images, or user-defined patterns. The designs can be printed or reproduced using laser printers, inkjet printers, or any other digital printing means including the conventional printing methods. Various types of inks can also be used to suit the design needs of the décor layer. Preferably, the ink used during the printing method comprises properties such as but is not limited to waterproofness, lightfastness, acid-free, metallic, glossy, sheen, shimmering, or deep black, among others. It is desirable that the decorative layer is visually exposed by the coating layer being a substantially transparent coating layer. The décor layer may comprise a pattern, wherein the pattern is printed via digital printing, inkjet printing, rotogravure printing machine, electronic line shaft (ELS) rotogravure printing machine, automatic plastic printing machine, offset printing, flexography, or rotary printing press. The thickness of the decorative layer is preferably in the range of 0.05 mm and 0.10 mm, for example substantially 0.07 mm.

Making use of at least two irradiation steps has several benefits. When further optimizing the method, it is beneficial to apply the first irradiation step for partial curing of the coating of the coating layer and the second irradiation step for further curing thereof. It is also conceivable that the second irradiation step is configured for enabling substantially full curing of the coating layer. The first irradiation step is preferably performed such that the coating layer is at least 10% cured before subjecting said coating layer to the second irradiation step. Preferably, the first irradiation step is performed such that the coating layer is at least 25% cured before subjecting said coating layer to the second irradiation step. More preferably, the first irradiation step is performed such that the coating layer is at least 50% cured, even more preferably at least 70%, before subjecting said coating layer to the second irradiation step. It is also conceivable that the first irradiation step is preferably performed such that the coating layer is at most 80% cured before subjecting said coating layer to the second irradiation step. Preferably, the first irradiation step is performed such that the coating layer is most 75% cured before subjecting said coating layer to the second irradiation step, more preferably at most 60%, at most 50% or at most 40%. The second irradiation step can obtain a further curing of the coating layer. Preferably at least the upper surface of the coating is fully cured after the second irradiation step. It is for example conceivable that at least the upper 50% of the coating layer is fully cured after the second irradiation step, in particular at least the upper 75% of the coating layer or the upper 80% of the coating layer.

The method according to the invention benefits of the result that it is no longer needed to apply matting agents in order to obtain the desired gloss level, and in particular the desired matte finish. Hence, the coating layer applied in the present invention is preferably substantially free of matting agents. Preferably, the coating layer, or the coating composition whereof the coating layer if formed, comprises at most 2 wt % of matting agents, preferably at most 1 wt %, more preferably at most 0.5 wt %. The top coating layer may comprise in the range of 0.05 to 0.5 wt % of matting agent, preferably in the range of 0.01 to 0.3 wt % of matting agent. Non-limiting examples of such matting agents are inorganic particles and/or ceramic particles, such as but not limited to Al2O3, SiO2, TiO2 and the like. It is beneficial to substantially fully omit the use of matting agents as the absence of matting agents has several benefits. Sedimentation of the matting agents during production is an often seen disadvantage. And in addition to that, the resulting embedded particles of the matting agents are easily removed from the surface in practice by friction during regular use as a floor panel, or even during production. The removal of the matting agents from the coating layer causing unwanted glossy spots and increased defect and waste rates. Hence, the quality of the panel can be seriously affected. In a further preferred embodiment, the coating composition, or the uncured coating layer is substantially free of volatile compounds. Furthermore, the method according to the invention avoids the creation or occurrence of shiny spots present in deep surface textures imitating real wood or stone grain.

The method according to the present invention is in particular suitable for use in combination with resilient panels. The thickness of the panel, in particular the floor panel or wall panel, as applied in the method according to the invention is preferably at most 10 mm, more preferably at most 8 mm. It is also conceivable that the thickness of core layer is at most 10 mm, more preferably at most 8 mm. It is conceivable that the thickness of the core layer is as thin as 0.9 mm. The core layer can also be called the carrier layer, carrier plate, carrier core and/or panel core. The core layer is in particular configured to provide rigidity and strength to allow a floating installation, and also provides a substantially flat surface on which to provide the decorative layer.

It is imaginable that the panel is heated prior to the panel being transported into the inert environment. The temperature up to which the panel, in particular the surface of the panel, is heated can be in the range of 50 to 70 degrees Celsius. Such panel would classify as a heated panel and such panel could have a viscosity gradient in the coating layer. The viscosity gradient in the coating layer at time of at least partial curing of the at least one coating composition of the coating layer could positively contribute to the crosslinking rate gradient in the coating layer which achieves a matte effect. As indicated before, the matte effect is particularly resistant to gloss and slip resistance deterioration due to the absence of matting agents.

The method enables the production of a panel having a coating layer which comprises microstructures. Typically, after at least one of the irradiating steps, one or more microstructures are formed in the coating layer. At least one of the irradiating steps is preferably performed such that one or more microstructures are formed in the coating layer. Such one or more microstructures typically form a matte, super matte, ultra-matte, or low gloss finish on the top surface of the panel or in the coating layer. The microstructures could also be referred to as micro-undulations, micro creases, microfolds, or creases or defines as microstructure comprising micro-undulations, micro creases, microfolds, or creases. As indicated, said microstructures can be are formed after one or more irradiating steps. The degree of the induced microstructures or microfolds vary depending on the irradiating steps. The microstructures comprising microfolds or creases could in a preferred embodiment be conceived as a process of photochemical micro-structuring that occurs in the UV coating or coating layer. During the formation of the microstructures, typically high energy ultraviolet (UV) light penetrates into at least a part of the coating layer in which polymerization only happens on said exposed part. Volume contraction then follows which typically leads to micro-wrinkling of the surface thereof thereby creating a microstructure within the coating layer. Hence, preferably, at least part of the coating layer reduces in size or shrinks during the irradiation steps due to the internal stress as caused by the crosslinking of the polymers in the coating layer. This then forms a rough surface in the coating layer. Alternatively within the context of the present invention, if a microstructure is desired, it is also conceivable that such microstructure is produced via the volatilization of solvent or moisture, the increase of pigment volume concentration (PVC) results in a viscoelastic system, and/or the deposition of matting agent particles on the surface of the coating layer.

In a preferred embodiment of the method, the second wavelength is longer than the first wavelength. The second wavelength is particularly chosen such that said wavelength could penetrate though the partially cured coating layer after said coating layer being subjected to the first irradiating step. The first wavelength is preferably in the range of 108 to 395 nm, in particular in the range of 108 to 250 nm, more in particular in the range of 160 to 180 nm. Most preferably the first wavelength is 172 nm. The second wavelength is preferably in the range of 250 to 405 nm. More preferably, the second wavelength is 395 nm. Typically, after the first and second irradiating step, the coating layer forms a highly crosslinked matrix at a depth of at least 5 μm, more preferably at least 10 μm, most preferably at least 20 μm. In a preferred embodiment, first irradiating step and/or the second irradiating step are exerted at a curing energy of 100 to 500 mJ/cm2, preferably between 200 and 400 mJ/cm2. Preferably, after the second irradiation step, the top coating forms a polymerization gradient comprising a very high crosslinking degree at its top surface and a lower crosslinking degree across the rest of its volume.

At least one coating layer is preferably applied via one or more applicator rollers. The applicator roller preferably has a Shore D hardness between 20 and 40 or ideally between 25 and 35. The system according to the present invention preferably comprises at least one applicator roller for applying a coating layer onto the panel.

It is conceivable that at least one, more preferably at least two coating layers are applied at least partially on at least the top surface of the panel. The bottommost coating layer can also be called a priming layer. It is also conceivable that the at least one priming layer is applied prior to the provision of at least one further coating and/or topmost coating layer or top coating, wherein said priming layer, at least one further coating and/or top coating most preferably comprise at least one acrylic monomer and/or oligomer and/or at least one photo-initiator. It is also imaginable that at least one priming layer forms part of the coating layer. In such case, it is possible that the coating layer comprises at least one priming layer and at least one top coating. It is conceivable that at least one priming layer is a gel layer or gel-like layer. The viscosity of the priming layer can equal the viscosity of the coating layer, in an uncured condition. The method according to the present invention may comprise the step of brushing the priming layer during and/or after its application on the decorative surface. By applying the priming layer via a brushing step and/or subjecting the priming layer to at least one brushing step after application, it is possible to use less primer. The use of a brushing step could also contribute to a more even spreading of the priming layer. It is also conceivable that at least one coating layer is applied via a brushing step. It is also conceivable that at least one coating layer is applied via a curtain coat applicator, a spray applicator, and the like. Alternatively, it is also possible the coating layer, preferably the top coating is applied via applicator rollers and brushed at least once after application. If applied, such applicator rollers preferably have a Shore D hardness between 20 and 40 or ideally between 25 and 35. This brushing step can avoid flooding of the panel surface texture, for example in case the panel or the decorative surface thereof comprises a texture to imitate a wood or stone grain, and can ensure the priming layer is applied in the deepest recesses, wood or stain grain, comprised of the texture. The method therefore also includes the step of applying the at least one coating layer, preferably at least the priming layer, onto a decorative surface comprising at least one recess forming a wood and/or stone grain, and subjecting it to at least one brushing step. It is typically not possible to brush the at least one top coating into a texture recess as underlying coating layers such as the at least one priming layer are not completely cured at this stage. As a result there is incomplete coating or the incomplete transfer of the top coating, which creates shiny spots, or spots of inconsistent gloss level, in a plurality of embossing or texture recesses due to the exposure of the bottom coating.

In a preferred embodiment, at least one coating layer is subjected to at least one texture gloss control step prior to the application of a top coating layer to form a texture gloss control layer. It is for example conceivable that the at least one texture gloss control step is performed after a brushing step, particularly after the at least one priming layer brushing step. It is for example conceivable that the at least one texture gloss control step is performed prior to providing a top coating layer and providing the panel in the inert environment. It is further conceivable that the at least one texture gloss control step is performed prior to providing at least one further coating layer, wherein the at least one further coating layer comprises at least one abrasive coating layer and/or a top coating layer. It is conceivable that the at least one further coating layer does not extend to cover the entire texture gloss control layer. The texture gloss control step is preferably an irradiating step which is performed at a wavelength of 395 nm and/or at a curing energy in a range of 100-500 mJ/cm2, most preferably at a range of 150-250 mJ/cm2. The texture gloss control step can be performed via a mercury vapor lamp or one or more metal vapor lamps preferably based on the light emission from mercury (Hg) atoms, in particular wherein the mercury lamps operate between 320 to 440 nm. It is also conceivable that the gloss control step is performed at a wavelength of 240 to 280 nm. The texture gloss control step could also be performed via at least one alkali metal vapor lamp or at least one light source chosen from the group comprising a potassium lamp, potassium salt lamp, preferably an atomic potassium lamp, or more preferably an atomic potassium hot cathode lamp, or an LED lamp, preferably operating between 240-280 nm. Preferably, the average wavelength of the applied lamp is at least partially lower than 300 nm, or lower than 250 nm. In a preferred embodiment, the texture gloss control step cures the at least one coating layer, preferably at least one priming layer in particular such that a gel-like or tackified but preferably incompletely cured surface is obtained. Preferably, the potassium lamp or the gloss control step has an energy level between 28 to 144 mJ/cm2 and/or a power level between 88 to 420 mW/cm2. It is possible that the potassium lamp or the texture gloss control step create at least partially a wrinkled structure on the top surface of the at least one coating layer, preferably at least one priming layer, including on the top surface of the coating layer provided at least partially in the wood and/or stone texture recesses, creating a basis for a matte or low gloss effect, preferably with a gloss level within 2 Gu. The panel according to the present invention in this case still comprises microstructures or tactile features such as deep texture recesses or deep embossing having up to 0.2, preferably even up to 0.4 mm depth or more. It is therefore conceivable that the panel comprises at least one texture gloss control layer, wherein the texture gloss control layer is present at the bottom of deep texture recesses or deep embossings having up to 0.2, preferably up to 0.4 mm depth, and is at least partially not covered by any further coating layers and/or top layer. It is conceivable that at least one coating layer present on top of the texture gloss control layer is removed by chemical or abrading means to expose at least part of the one texture gloss control layer. By means of this texture gloss control layer, a consistent sheen or gloss at the top surface and/or bottom of at least one recess, preferably a plurality of recesses comprising the surface texture can be achieved.

In a possible embodiment, the coating layer, topmost coating and/or top coating is subjected to at least one pre-gelling step prior to the first irradiation step. It is for example conceivable that the pre-gelling step is performed prior to providing the panel in the inert environment. The pre-gelling step is preferably an irradiating step which is performed at a wavelength of 395 nm and/or at a curing energy in a range of 100-500 mJ/cm2, most preferably at a range of 150-250 mJ/cm2. The pre-gelling step can be performed via a mercury vapor lamp, LED lamp or one or more metal vapor lamps preferably based on the light emission from mercury (Hg) atoms, in particular wherein the mercury lamps operate between 320 to 440 nm. It is also conceivable that the pre-gelling step is performed at a wavelength of 240 to 280 nm. It is conceivable that the pre-gelling step achieves a partial but consistent through curing of the at least one coating layer, and/or activates at least part of the photo-initiators present in the at least one coating layer prior to introducing the panel into the at least one inert chamber.

The invention also relates to a system for curing a coating layer of a decorative floor panel or wall panel, comprising:
at least one inert chamber, said inert chamber comprising:
   at least one gas regulation unit for regulating the provision of inert gas to the inert chamber;
   at least one first irradiation unit configured for irradiation with a first wavelength; and
   at least one second irradiation unit configured for irradiation with a second wavelength;
at least one conveyer for transporting at least one panel;
   wherein the inert chamber further comprises an inlet and outlet between which the conveyor extends and wherein the conveyor and the first irradiation unit and second irradiation unit are positioned such that a panel provided upon the conveyor is exposed to radiation of the first irradiation unit and of the second irradiation unit during transport through the inert chamber.

The system according to the present invention can be applied to the method according to the invention and vice versa. The use of an inert chamber as applied in the system according to the invention, in combination with a conveyer for transporting at last one panel enables that a panel provided upon the conveyor is exposed to radiation of the first irradiation unit and of the second irradiation unit during transport through the inert chamber. In this way, the curing of a coating layer of a decorative panel can be done in an efficient and effective way. The first irradiation unit and/or the second irradiation unit typically comprises a light source or ultraviolet (UV) light source. It is conceivable that the first irradiation unit and the second irradiation unit are configured to independently operate at a controlled power level. It is for example conceivable that the first irradiation unit operates at its maximum power while the second irradiation unit operates at approximately 70% of its maximum power.

It is beneficial if the inert chamber comprises at least one oxygen sensor. The gas regulation unit could for example be programmed to base the regulation and provision of inert gas based upon the determined oxygen level. It is for example conceivable that the inert environment is regulated upon a maximum of 50 ppm of oxygen. It is preferred to control the oxygen level such that the oxygen level is below the threshold level that indicates oxygen contamination.

Preferably, the inert chamber comprises at least one closing element for at least temporarily and/or at least partially closing the outlet of the inert chamber. The closing element could also be referred to as sealing element. The at least one closing element is preferably configured to close the outlet in a temporary manner. The closing element can for example ensure that the non-reactive gas, such as nitrogen and/or an inert gas, will not escape from the inert chamber. The use of at least one closing element prevents large amounts of nitrogen and/or an inert gas to be fully flushed though the inert chamber during production. In a conventional system this generally is up to 120 to 150 m3/hour. The latter is further exacerbated by a drawback in current conventional short wavelength curing module design, as generally the inert chamber only comprises a surface curing unit, while a full curing depends on an at least one further UV curing unit placed further down the line. There is no possibility of sealing the inert chamber of conventional systems at its outfeed due to the uncured state of the coating at this location, as any mechanical sealing means which might come into contact with the surface of the panel or board passing through would damage the coating in this uncured state. Since the design according to the present invention enables that fully curing of the coating layer is done via the second irradiation unit, enables that a more sustainable design of the inert chamber can be applied. The inert chamber could also comprise at least one closing element for closing the inlet. Preferably, at least one closing element is substantially flexible. In this way, the closing element could be displaced easily between a closed and an opened position. It is for example conceivable that the flexible closing element is configured to open upon contact with the panel which is transported through the outlet. The at least one closing element could for example be designed such that it engages the conveyor. In this way, the closing element will substantially fully close the outlet in an initial state. The inert gas and/or nitrogen consumption according to the current invention is thereby reduced at least 60% from the conventional 120 to 150 m3/hour to 40 m3/hour, offering a substantial increase in production efficiency.

The conveyor can for example be a conveyer belt chosen from the group of a mesh conveyer belt, a net conveyer belt, a perforated conveyer belt, or combinations thereof. The conveyor preferably operates at a speed of at least 15 m/min, more preferably at least 20 m/min, and further preferably at least 25 m/min. The system could comprise at least one drive unit which is configured for driving the conveyor. The system could also comprise at least one control unit for controlling the conveyor and/or drive unit and/or for controlling the gas flow. In some embodiments the control unit is configured for controlling conveyor and or gas flow of the gas regulation unit.

At least one conveyor and/or at least one conveyor belt is preferably at least partially permeable for air. Hence, the conveyor and/or the conveyor belt can, for example, comprise a mesh- or net-type material or a material comprising of a plurality of holes. In this way, an air flow can be obtained through the conveyor. This is beneficial for the gas flow around the panel positioned upon the conveyor. More in particular, the use of a conveyor and/or conveyor belt which is at least partially permeable for air enables that nitrogen and/or an inert gas can be present on at least two, more preferably at least four, most preferably all surfaces of the panel. This enables oxygen to be flushed out through the conveyor and/or the conveyor belt. Conventional solid surface galvanized rubber conveyer belt may trap oxygen between its surface and the panel or board passing through, especially at the high production speeds required for resilient flooring or wall panels. The trapped oxygen will be slowly dispersed from underneath the panel, which then results in oxygen contamination in the inert chamber. When said panel reaches the surface curing unit, the dispersed oxygen will prevent the highly energetic radiation exerted by the surface curing unit from reaching the surface of the panel to be cured, forming ozone instead through an oxygen-ozone reaction. This will then result to improper surface curing in the spots contaminated with the dispersed oxygen. This is again solved through the use of a mesh- or net-type or perforated conveyor belt which prevents the oxygen from being trapped by allowing the oxygen to be flushed out from underneath the panel immediately upon entry in the inert environment. So, at which time the panel reaches the surface curing unit, there is no contamination by oxygen. Thus, the short wavelength radiation from the surface curing unit can reach the surface of the panel normally ensuring that there are no issues caused by improper curing. Preferably, the conveyor and/or the conveyor belt is an open mesh type. The mesh can be Teflon, PTFE, PTFE-coated mesh, nylon, Kevlar, PTFE Kevlar with glass fabric, aramid, aramid-glass, Nomex dryer belt, fluorocarbon, PTFE coated fiberglass, fiberglass, PTFE and glass, PTFE glass fabric, PTFE glass with anti-static properties, Nomex dryer belt, resin impregnated mesh, resin coated open-mesh belting fabrics, or combinations thereof.

At least one conveyor is preferably configured to transport a panel in a traverse configuration. Hence, the length direction of panel is preferably substantially perpendicular to travel direction. This is beneficial from a spatial point of view, and also when considering the efficiency of the irradiation process. In particular the second irradiating step can be performed substantially immediately after the first irradiating step.

The gas regulation unit is preferably configured to provide at least one inert gas with a volume flow rate of at most 70 m3/hour, preferably at most 60 m3/hour, most preferably at most 40 m3/hour. The at least one gas infeed or gas inlet can for example be configured to operate at a pressure level between 3 to 8 bar, or preferably between 4 to 6 bar.

When it is referred to an inert gas in particular a non-reactive gas is meant. Non-limiting examples of the inert gas or non-reactive gas as applied within the context of the present invention are nitrogen (N) or a gas chosen from helium (He), neon (Ne), argon (Ar), krypton (Kr), xenon (Xe), radon (Rn), oganesson (Og), or combinations thereof.

The first irradiation unit could for example comprise at least one reflector, collimator, polarizer and/or at least one element for focusing light. This could positively contribute to further efficiency of the system. The more focused the radiation of the irradiation unit is, the more effective the irradiating step can be performed. It is also conceivable that at least one second irradiation unit comprises at least one reflector, collimator, polarizer and/or at least one element for focusing light. These use of at least one light guiding element enables light from a irradiation unit to form a narrow, focused beam which is directed towards the surface to be cured. This allows more efficient energy dissipation and curing. Preferably, the at least one reflector, if applied, is chosen from the group comprising an elliptical reflector, parabolic reflector, off-axis elliptical UV lamp reflector, off-axis parabolic UV reflector, dual focal point elliptical UV lamp reflector, or combinations thereof. It is preferred that the at least one reflector promotes a substantially uniform distribution of the energy of the irradiation source. In some cases, such as in high-power applications, the reflector can be enclosed in a housing having a forced air-cooling to draw air from both ends to create an end cooled reflector assembly, or a center hole on the top of the housing to create a center cooled reflector assembly.

The first wavelength of the first irradiation unit is preferably in the range of 108 to 250 nm, in particular in the range of 160 to 180 nm. More preferably, the first wavelength is 172 nm. The second wavelength of the second irradiation unit is preferably in the range of 250 to 405 nm. Preferably, first irradiation unit and/or the second irradiation unit operates at a photon energy level between 3 to 12 electron volts (eV). Possibly, the at least one first irradiation unit and/or the second irradiation unit comprises a working complex formed between two fluorophore molecules of the same type, chosen from the group comprising NeF, Ar2, Kr2, F2, ArBr, Xe2, ArCl, KrI, ArF, KrBr, KrCl, KrF, XeI, Cl12, XeBr, Br2, XeCl, I2, and XeF.

The system could further comprise at least one brush or brushing unit configured for brushing at least one priming layer onto the panel. The at least one brushing unit preferably comprises at least one circular or cylinder brush, which is preferably configures to rotate in a clockwise direction. At least one brush unit could for example comprise a plurality of brushes of a material chosen from the group of wool, animal wool, natural fiber, chunking bristle, boar bristle, tampico, plant wool, cellulose wool, nylon, antistatic nylon, polyethylene, PVC, styrene and/or polystyrene. At least one brush preferably has a length of at least 5 mm, preferably at least 15 mm and/or a diameter at the tip of at most 1 mm, more preferably at most 0.5 mm, most preferably at most 0.1 mm. Such brush diameters at the tip allows a sufficient coverage of the applied and brushed coating on the top surface of the panel.

The system could also comprise at least one gloss control unit. The gloss control unit could for example be configured for performing at least one curing step. The pre-gelling unit could for example comprise mercury vapor lamp or one or more metal vapor lamps preferably based on the light emission from mercury (Hg) atoms, in particular wherein the mercury lamps operate between 320 to 440 nm. The gloss control unit could also comprise at least one alkali metal vapor lamp or at least one light source chosen from the group comprising a potassium lamp, potassium salt lamp, preferably an atomic potassium lamp, or more preferably an atomic potassium hot cathode lamp, or an LED lamp, preferably operating between 240-280 nm. Preferably, the average wavelength of the applied lamp is at least partially lower than 300 nm, or lower than 250 nm. Preferably, the potassium lamp or the gloss control unit has an energy level between 28 to 144 mJ/cm2 and/or a power level between 88 to 420 mW/cm2

The system could also comprise at least one pre-gelling unit. The pre-gelling unit could for example be configured for performing at least one pre-curing step. The pre-gelling unit could for example comprise mercury vapor lamp or one or more metal vapor lamps preferably based on the light emission from mercury (Hg) atoms, in particular wherein the mercury lamps operate between 320 to 440 nm.

The system could also comprise at least one subsequent final curing unit. The final curing unit could for example comprise one or more ultraviolet (UV) light sources. The final curing unit could for example comprise at least one ultra high energy UV lamps or light sources, with an energy of at least at least 500, more preferably at least 600, most preferably at least 700 mJ/cm2 and/or an intensity, illumination energy or power per unit area of at least 1,000 mW/cm, more preferably at least 2,000 mW/cm2, most preferably at least 2,500 mW/cm2 The ultra high energy UV lamp or light source preferably comprises a cooled or chilled reflector system.

The combination of the different components of the system according to the invention, allows to produce a panel according to the method of the invention, which shows an unexpected improvements in surface properties, such as improved surface scratch, scratch resistance, and gloss retention, with an increase of 40% in surface scratch resistance when tested to ISO 1518 (2800 g vs 2000 g), and an improvement of microscratch and gloss retention when tested according to EN 16094, resulting in best in class B1 and A1 gradings.

Comparing with the production process disclosed in the prior art, the system according to the invention provides a reduction in energy consumption of up to 60%, down to 25.27 kWh from 67.67 k Wh using conventional means according to the prior art. Alternative options are UV curing devices related to super UV such as: microwave UV (uses electrode-less, long lasting UV bulbs, faster curing speeds, lower heat output) for example having the following parameters:
watts per inch: 157-236 W/cm or 400-600 W/in
unlimited maximum cure length when positioned end to end
peak irradiance up to 8.0 W/cm2 UVA
used for maximum energy savings/faster curing speeds, fewer lamps.

The invention also relates to a decorative floor panel or wall panel, comprising at least one core layer, at least one decorative surface and at least one coating layer provided upon the decorative surface. The at least one coating layer preferably has a surface roughness (Ra) of at least 1 μm. The coefficient of friction (COF) of the at least one coating layer is preferably at least 0.4 and/or a pendulum slip resistance (PTV) of the at least one coating layer is at least 36, preferably at least 61 according to ISO BS 7976-2.

The coating layer of the panel according to the present invention could comprise a plurality of microstructures having a plurality of peaks and valleys. The surface roughness of at least part of the coating layer, in particular, the upper coating surface, is preferably at least 1 μm Ra, more preferably at least 2 μm Ra, even more preferably at least 3 μm Ra. At least part of the coating layer may comprise a plurality of micro-undulations while maintaining a surface roughness (Ra) of at least 3 μm, wherein at least a part of the micro-undulations has a peak to valley height (Rz) of 5 μm or more and/or wherein at least a part of the micro-undulations has a peak to valley height (Rz) of at least 10 μm. At least part of the coating layer may also comprise a plurality of micro-undulations while maintaining a surface roughness (Ra) of at least 3 μm, wherein at least a part of the micro-undulations has a peak to valley height (Ry) of 5 μm or less and/or wherein at least a part of the micro-undulations has a peak to valley height (Ry) of at least 3 μm.

In some embodiments, the surface of the coating layer comprises varying surface heights forming peaks and valleys. Different dimensional characteristics can be measured using the said surface heights, peaks, and valleys. These dimensional characteristics must be specified to positively affect the slip resistance of the surface. For example, R3z or the mean of the third maximum peak-to-valley heights in the evaluation length can preferably set to at least 5 μm. Moreover, the maximum height of the third highest peak to the third lowest valley in each cut-off length, denoted by R3y, can also be preferably set to at least 5 μm. Such embodiment would enable sufficient slip resistance for the surface of the coating layer, and thus for the panel as such. The obtained roughness and/or peak to valley high can for example be achieved by having multiple coating layers each with micro-undulations and/or micro creases with a compounding effect. As such, the microstructures functions as a means for increasing the slip resistance of the surface of the coating layer. The panel according to the invention therefore features a COF slip resistance of at least 0.4, and/or a dry PTV slip resistance of at least 36, preferably at least 61 when measured with BPT ISO BS 7976-2.

In another embodiment, the system further comprises a nitrogen curtain or screen which is preferably positioned below the first irradiation unit. Said nitrogen curtain or screen is intended to accelerate nitrogen such that it can go through a narrow discharge at a discharge or flow angle of 10-20 degrees, ideally around 15 degrees, with a discharge or flow velocity of 1-15 m/s, ideally 2-5 m/s, along the length of the at least one irradiation unit. Said length of the at least one irradiation unit may substantially be equal to the width of the conveyer of the system. A laminar airflow is achieved across and below the first irradiation unit at this flow angle and velocity. Said laminar airflow is deemed to at least partially prevent volatiles from reaching the first irradiation unit. It is also deemed to create a nitrogen-rich environment that substantially displaces oxygen, which can react with the volatiles. As a result, volatiles are kept from depositing on the system's reflectors and/or irradiation unit's surface, preventing discoloration, yellowing, or staining. Consequently, the irradiation unit's UV light intensity is sustained for an extended duration. Additionally, this guarantees that the reflectors and irradiation units can produce the proper peak irradiance and wavelength to accomplish the required adhesion and depth of cure, leading to high-quality curing.

The invention also relates to a decorative floor panel or wall panel, comprising at least one core layer, at least one decorative surface, at least two coating layers provided upon the decorative surface comprising at least one sheen control coating layer and at least one top coating layer, wherein the decorative surface and/or at least two coating layers comprise a texture imitating a wood and/or stone look comprising at least one cavity, more preferably a plurality of cavities. The at least one cavity, more preferably plurality of cavities, forms at least one, preferably a multitude of surface areas B at a texture or cavity depth d. The top coating layer forms a second surface area A equal to the total surface area of the panel minus surface area B. According to the invention, the sheen or gloss level of surface area A and surface area B are at least within 5 Gu, more preferably within 2 Gu difference. In one embodiment, the sheen control coating layer is exposed at least partially by abrading or chemical means during the production process. In another embodiment, the sheen control coating layer is at least partially covered by the at least one top coating layer. It is conceivable that the at least one sheen control coating layer is a priming layer with a controlled surface gloss or sheen level. It is conceivable that the sheen control coating layer comprises matting agents and/or is a matte coating layer with a surface sheen of 1-15 Gu, more preferably 2-10 Gu, more preferably 3-5 Gu. The sheen or gloss level of the second surface area can be 2-3 Gu lower than the sheen or gloss level of the second surface area, and preferably 1 Gu.

The panel can be obtained via the method according to the present invention and/or by making use of the system according to the present invention.

The panel preferably comprises a coating layer having a highly crosslinked matrix at a depth of at least 5 μm, more preferably at least 10 μm, most preferably at least 20 μm from the top surface of the coating layer. At least part of the at least one coating layer could comprise a plurality of microstructures, wherein at least part of the microstructures has a peak to valley height (Rz) of at least 10 μm. This creates a plurality of microstructures on the top surface of the coating layer. The microstructures could optionally also be referred to as crust. The panel according to the invention, and in particular the coating layer thereof preferably has a gloss level or sheen level of at most 4 Gu, preferably at most 3 Gu.

The invention will be further elucidated by means of non-limiting exemplary embodiments illustrated in the following figures, in which the FIGURE shows a possible embodiment of a system according to the present invention.

The FIGURE shows a possible embodiment of a system 100 according to the present invention. The system 100 is configured for curing a coating layer of a decorative floor panel 110 or wall panel 110. The system comprises an inert chamber 104 comprising a gas regulation unit 112 for regulating the provision of inert gas to the inert chamber 104, a first irradiation unit 102 configured for irradiation with a first wavelength and a second irradiation unit 103 configured for irradiation with a second wavelength. The system 100 further comprises a conveyer 106 for transporting the panels 110. In the shown embodiment, the conveyor 106 guides the panel 110 in traversing the inert chamber 104. The inert chamber 104 further comprises an inlet and outlet 108 between which the conveyor 106 extends. The conveyor 106 and the first irradiation unit 102 and second irradiation unit 103 are positioned such that a panel 110 provided upon the conveyor 106 is exposed to radiation of the first irradiation unit 102 and of the second irradiation unit 103 during transport through the inert chamber. The inert chamber 104 preferably comprises at least one oxygen sensor (not shown). The inert chamber 104 comprises a closing element 111 for at least temporarily closing the outlet 108 of the inert chamber 104. The closing element 111 is thereby configured to engage the conveyor 106. Since the second irradiation unit 103 performs a second irradiating step to sufficiently cure the coating layer to provide sufficient toughness, sufficiently solidifying the coating layer to enable it to pass the closing element 111 without being removed or damaged physically. The use of the closing element 111 allows to further reduce the required infeed of the inert gas to be reduced to at least half, preferably at least 30% of the inert gas according to the state of the art. The conveyor 106 is further at least partially permeable for air. The system 100 further comprises optionally a pre-gelling unit and/or a subsequent final curing unit 105. The first conveyor unit 106 comprises in the shown embodiment a conveyor belt 116 that is operated by a head pulley 113, a tail pulley 114, and a plurality of carrying idlers 115 in between the head pulley 113 and the tail pulley 114. The head pulley 113 and the tail pulley 114 act as the main drivers in operating the first conveyor unit 106 while the plurality of carrying idlers 115 are positioned in substantially equidistant points to support the conveyor belt 116 carrying the panel 110. This problem has been observed when the panel 110 being made of a resilient or flexible thermoplastic material is subjected to heat during pre-gelling, pre-heating, or the primer application which generally causes at least a slight deformation. This deformation, in effect a wavy unevenness of up to 5 mm, in some cases even up to 10 mm when measured to ISO 10582-Annex B “Determination of Flatness”, causing the board or panel to have an uneven bottom surface. When the panel having this uneven bottom surface enters the inert chamber 104 and touches a conveyor belt made of a solid material such as galvanized rubber, polyurethane or PVC, as is common in the industry, oxygen is trapped between the (resilient) floor panel 110 and the solid surface conveyer belt. During the residence time of the panel 110 in the inert chamber 104, oxygen will be slowly dispersed from underneath the panel 110, which then results in oxygen contamination in the inert chamber 104. When said panel reaches the first irradiating unit 102, the thusly dispersed oxygen will prevent the highly energetic radiation exerted by the first irradiating unit 102 from reaching the surface of the panel to be cured, forming ozone instead through an oxygen-ozone reaction. This will then result to improper surface curing in the spots contaminated with the dispersed oxygen. This is again solved through the use of a mesh- or net-type or perforated conveyor belt 116 which prevents the oxygen from being trapped by allowing the oxygen to be flushed out from underneath the panel immediately upon entry in the inert environment. So, at which time the panel 110 reaches the first irradiating unit 102, there is no contamination by oxygen. Thus, the short wavelength radiation from the first irradiating unit 102 can reach the surface of the panel 110 normally ensuring that there are no issues caused by improper curing.

The inert chamber 104 further comprises a closable outlet 108 making use of at least one closing and/or sealing element 111. Preferably, the at least one closing element and/or sealing means 111 is placed in between the second irradiation unit 103 and the tail pulley 114. The at least one closing element and/or sealing means 111 preferably comprises a flexible material that effectively seals the outlet of the inert chamber 104 by making direct contact with the conveyer 109 but also allows the panel 110 to pass through. The at least one sealing means 111 is also, preferably, at the height of the tail pulley 114. Moreover, the at least one sealing means 111 also acts as a gateway to an optional second conveyor unit 109 that operates with the final curing unit 105. The material of the at least one sealing means 111 can be any flexible material such as rubber, PVC, polyurethane, polyethylene, polypropylene and the like.

It was experimentally found that a panel produced to the current production method has an unexpected advantage in the scratch resistance and microscratch resistance. In a possible embodiment, wherein the panel has a micro scratch performance, or micro scratch resistance, of at least MSR-B3 and/or a gloss retention performance, or gloss retention resistance, of at least MSR-A2 when tested according to EN 16094 preferably in combination with a mass of at least 16 N, more preferably at least 32 N and at least 80 R, more preferably at least 160 R, where conventional panels produced according to the prior art only pass MSR-B3/A2 when tested at a mass of 4N/6N. It is also conceivable that the panel has a surface scratch of at least 1800 g, preferably at least 2200 g, more preferably at least 2500 g when tested according to ISO 1518.

The panel according to the invention also unexpectedly features an improved surface roughness and/or slip resistance, an improved gloss/sheen endurance and slip resistance endurance compared to the prior art.

The panel obtained via the method according to the present invention and/or by making use of the system according to the present invention has an unexpected advantage in the scratch resistance and microscratch resistance. When the panel is tested using surface performance tests. Based on Martindale (WI-QA4-S066):

the microscratch resistance/performance is MSR-B3 or better when tested according to EN 16094 and the gloss retention performance of MSR-A2 or better when tested according to EN 16094. Surface Scratch results tested according to ISO 1518 of at least 1800 g, in particular at least 2200 g, more in particular at least 2500 g are obtained. Slip resistance performances of at least P3 tested according to AS 4586, COF of at least 0.4 when tested according to EN 13893 are obtained. Furthermore, slip resistance endurance and gloss endurance are greatly enhanced with a change in gloss of less than 10%, preferably less than 5%, when exposing the surface of the panel obtained via the method according to the present invention and/or by making use of the system according to the present invention to at least 10,000, preferably at least 25,000, most preferably at least 35,000 revolutions when testing 60 degree gloss or sheen before and after NALFA/ISO 4918 with at least 90 kg, and preferably at least 120 kg assembly weight.

### Clauses

The invention is further elucidated based on the following non-limitative clauses.

1. Method for curing a coating layer of a decorative floor panel or wall panel, comprising the steps of:
providing at least one panel, in particular a floor panel or wall panel, said panel comprising at least one core layer and at least one decorative surface;
providing at least one coating layer, in particular an uncured coating layer, upon at least part of the decorative surface of the panel;
subjecting at least part of the coating layer to a first irradiation step for a first time period at a first wavelength;
subjecting at least part of the coating layer to a second irradiation step for a second time period at a second wavelength;
   wherein the first irradiation step and the second irradiation step are performed in an inert environment.

2. Method according to clause 1, wherein the first irradiation step and the second irradiation step are subsequent steps performed in the same inert environment.

3. Method according to any of the previous clauses, wherein at least one coating layer comprises at least one acrylic monomer and/or oligomer

wherein at least one coating layer comprises at least one photo-initiator.
wherein at least one photo-initiator comprises acrylate- or styrene-based formulations, methyl-2-benzoylbenzoate, 2-hydroxy-2-methyl-1-phenyl-1 propanone, benzyl dimethyl ketal, 1-hydroxy-cyclohexylphenyl-ketone, or methyl benzoyl formate, or other photo-initiator, or any combination thereof, wherein at least one coating layer comprises in the range of 2 wt % to 10 wt % of at least one photo-initiator based on total weight of the coating formulation

4. Method according to any of the previous clauses, wherein the viscosity of the at least one uncured coating layer is in the range of 96 to 683 centistokes (cSt), and/or, wherein the viscosity of the coating layer is preferably smaller than 5000 mPa·s at 25 degrees Celsius, preferably between 500 and 3000 mPa·s at 25 degrees Celsius and more preferably between 800 and 1500 mPa·s at 25 degrees Celsius, in particular in an uncured condition.

5. Method according to any of the previous clauses, wherein the coating layer is substantially free of matting agents.

6. Method according to any of the previous clauses, wherein the panel is at least partially composed of a resilient material and the thickness of the panel is at most 8 mm.

7. Method according to any of the previous clauses, wherein the second wavelength is longer than the first wavelength.

8. Method according to any of the previous clauses, wherein the first wavelength is in the range of 108 to 250 nm, in particular in the range of 160 to 180 nm and/or wherein the second wavelength is in the range of 250 to 405 nm.

9. Method according to any of the previous clauses, wherein the coating layer is subjected to at least one pre-gelling step prior to the first irradiation step.

10. Method according to any of the previous clauses, wherein at least two coating layers are provided to the top surface of the decorative layer, wherein the at least two coating layers comprise at least one priming layer and at least one coating layer.

11. Method according to clause 10, comprising the step of brushing the priming layer.

12. Method according to clause 10 or 11, wherein a sheen control layer is applied between the priming layer and the top coating layer, and/or wherein the priming layer is a sheen control layer.

13. Method according to clause 12, comprising the step of partially curing the sheen control layer by means of a potassium UV lamp.

14. Method according to clause 12 or 13, comprising the step of mechanically and/or chemically removing the top layer to expose the sheen control layer.

15. Method according to any of the previous clauses, wherein a texture is provided in the decorative layer forming a first surface area and second surface area.

16. Method according to clause 15, wherein the sheen or gloss of first surface area is defined by the top coating layer and the sheen or gloss of second surface area is defined by the sheen control layer

17. Method according to clause 15 or 16, wherein the sheen or gloss of the first surface area and/or the second surface area is within 10 Gu, more preferably within 5 Gu, most preferably within 2 Gu

18. Method according to any of the previous clauses, wherein the panel is further subjected to a final curing step by a UV-A source at at least 1,000 mJ/cm2, more preferably at least 2,000 mJ/cm2, most preferably at least 2,500 mJ/cm2.

19. Method according to clause 18, wherein the final curing step is performed by a single UV-A source at a focal point of at most 5 cm, most preferably at most 3 cm.

20. System for curing a coating layer of a decorative floor panel or wall panel, comprising:
at least one inert chamber, said inert chamber comprising:
at least one gas regulation unit for regulating the provision of inert gas to the inert chamber;
at least one first irradiation unit configured for irradiation with a first wavelength; and
at least one second irradiation unit configured for irradiation with a second wavelength;
at least one conveyer for transporting at least one panel;
   wherein the inert chamber further comprises an inlet and outlet between which the conveyor extends and wherein the conveyor and the first irradiation unit and second irradiation unit are positioned such that a panel provided upon the conveyor is exposed to radiation of the first irradiation unit and of the second irradiation unit during transport through the inert chamber.

21. System according to clause 20, wherein the inert chamber comprises at least one oxygen sensor.

22. System according to clause 20 or clause 21, wherein the inert chamber comprises at least one closing element or sealing means for at least temporarily and/or partially closing the outlet of the inert chamber.

23. System according to clause 22, wherein at least one closing element is substantially flexible, and/or wherein at least one closing element engages the conveyor.

24. System according to any of clauses 20 to 23, wherein the conveyor and/or conveyer belt is chosen from the group of a mesh conveyer belt, a net conveyer belt, a perforated conveyer belt, or combinations thereof.

25. System according to any of clauses 20 to 24, wherein the at least one conveyor is at least partially permeable for air.

26. System according to any of clauses 20 to 25, wherein the at least one conveyor is configured to transport a panel in a traverse configuration.

27. System according to any of clauses 20 to 26, wherein the gas regulation unit is configured to provide at least one inert gas with a volume flow rate of at most 70 m3/hour, preferably at most 60 m3/hour, most preferably at most 50 m3/hour.

28. System according to any of clauses 20 to 27, wherein the first irradiation unit comprises at least one reflector, collimator, polarizer and/or at least one element for focusing light.

29. System according to any of clauses 20 to 28, wherein the first wavelength is in the range of 108 to 250 nm, in particular in the range of 160 to 180 nm and/or wherein the second wavelength is in the range of 250 to 395 nm.

30. System according to any of clauses 20 to 29, further comprising at least one pre-gelling unit.

31. System according to any of clauses 20 to 30, further comprising at least one subsequent final curing unit.

32. Decorative floor panel or wall panel, comprising:
at least one core layer;
at least one decorative surface; and
at least one coating layer provided upon the decorative surface,
   wherein the coefficient of friction (COF) of the at least one coating layer is at least 0.4 and/or wherein a pendulum slip resistance (PTV) of the at least one coating layer is at least 36, most preferably at least 61 according to ISO BS 7976-2.

33. Panel according to clause 32, wherein the panel has a difference in gloss of less than 10%, preferably less than 5%, when tested before and after 10,000, preferably at least 25,000, most preferably at least 35,000 revolutions according to NALFA/ISO 4918 with at least 90 kg, preferably at least 120 kg assembly weight.

34. Panel according to clause 32 or 33, wherein the panel has a difference in PTV slip resistance of less than 20%, preferably less than 15%, most preferably less than 10%, when tested before and after 10,000, preferably at least 25,000, most preferably at least 35,000 revolutions according to NALFA/ISO 4918 with at least 90 kg, preferably at least 120 kg assembly weight.

35. Panel according to any of clauses 32 to 34, wherein the at least one coating layer has a surface roughness (Ra) of at least 1 μm.

36. Panel according to any of clauses 32 to 35, wherein the panel is processed or finished via the method of any of claims 1 to 16 and/or by making use of the system according to any of claims 17 to 29.

37. Panel according to any of clauses 32 to 36, wherein at least two coating layers are provided, wherein the two coating layers comprise at least one primer layer and at least one top coating,

38. Panel according to any of clauses 32 to 37, wherein at least one primer layer is a gloss or sheen control layer

39. Panel according to any of clauses 32 to 38, wherein between the primer layer and the top coating, there is at least one white base layer, a digitally printed visual comprising inks, and/or a surface adhesion layer

40. Panel according to any of clauses 32 to 39, wherein between the surface adhesion layer and the top coating, a gloss or sheen control layer is applied.

41. Panel according to any of clauses 32 to 40, wherein the gloss or sheen control layer is exposed by means of mechanical and/or chemical means.

42. Panel according to any of clauses 32 to 41, wherein at least part of the at least one coating layer comprises a plurality of microstructures, wherein at least part of the microstructures has a peak to valley height (Rz) of at least 10 μm.

43. Panel according to any of clauses 32 to 42, wherein the gloss or sheen level of the at least one coating layer, preferably the top coating, is at most 4 Gu, preferably at most 3 Gu.

44. Panel according to any of clauses 32 to 43, comprising a texture on the top surface, with texture comprising a plurality of cavities forming a first surface area and a second surface area, wherein the top surface area is the sum of the first surface area and the second surface area, wherein the first surface area and/or the second surface area have a gloss level difference of less than 10 Gu, more preferably less than 5 Gu, most preferably less than 2 Gu.

45. Panel according to any of clauses 32 to 44, wherein the second surface area is at least partially formed by at least one gloss or sheen control layer.

46. Panel according to any of clauses 32 to 45, wherein the panel has a micro scratch resistance of at least MSR-B3 and/or a gloss retention performance of at least MSR-A2 when tested according to EN 16094 preferably in combination with a mass of at least 16 N, more preferably at least 32 N and at least 80 R, more preferably at least 160 R.

47. Panel according to any of clauses 32 to 46, wherein the panel has a surface scratch of at least 1800 g, preferably at least 2200 g, more preferably at least 2500 g, when tested to ISO 1518.

48. A system for curing a coating layer of a decorative floor panel or wall panel, comprising:
at least one inert chamber, said inert chamber comprising:
   at least one gas regulation unit for regulating the provision of inert gas to the inert chamber;
   at least one first irradiation unit configured for irradiation with a first wavelength; and
   at least one second irradiation unit configured for irradiation with a second wavelength;
at least one conveyer for transporting at least one panel;
   wherein the inert chamber further comprises an inlet and outlet between which the conveyor extends and wherein the conveyor and the first irradiation unit and second irradiation unit are positioned such that a panel provided upon the conveyor is exposed to radiation of the first irradiation unit and of the second irradiation unit during transport through the inert chamber;
   wherein the inert chamber comprises at least one closing element or sealing means for at least temporarily and/or partially closing the outlet of the inert chamber; wherein the conveyor and/or conveyer belt is chosen from the group of a mesh conveyer belt, a net conveyer belt, a perforated conveyer belt, or combinations thereof, and wherein the at least one conveyor is at least partially permeable for air;
   wherein the first wavelength is in the range of 108 to 250 nm and/or wherein the second wavelength is in the range of 250 to 395 nm; and
   wherein the system further comprising at least one pre-gelling unit and at least one subsequent final curing unit.

49. The system according to clause 48, further comprising a nitrogen curtain or screen positioned below the first irradiation unit,

wherein said nitrogen curtain or screen accelerates nitrogen through a narrow discharge along the length of the air curtain creating a laminar airflow across the first irradiation unit at a discharge angle and discharge velocity, and
wherein said laminar airflow at least partially prevents volatiles from reaching said first irradiation unit.

50. The system according to clause 48 or 49, wherein the discharge angle is preferably 10-20, most preferably around 15 degrees to the horizontal plane and wherein the discharge velocity is preferably 1-15 m/s, most preferably 2-5 m/s.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A decorative floor panel or wall panel, comprising:
at least one core layer;
at least one decorative surface comprising at least one decorative print; and
at least one coating layer provided upon the decorative surface;
wherein the at least one coating layer comprises at least one primer layer and at least one top coating layer;
wherein the at least one top coating layer comprises at most 0.5 wt % of matting agents,
wherein the gloss or sheen level of the at least one top coating layer is at most 4 Gu; and
wherein said panel comprises a texture on the top surface, said texture comprising a plurality of cavities or recesses forming a first surface area and a second surface area, wherein the first surface area and/or the second surface area have a gloss level difference of less than 10 Gu, and wherein the sum of the first surface area and the second surface area forms the top surface area.

2. The panel according to claim 1, wherein the at least one coating layer comprises a crosslinked matrix at a depth of at least 20 μm and/or wherein the at least one top coating layer comprises a polymerization gradient having a relatively high crosslinking degree at its top surface and a lower crosslinking degree across the rest of its volume.

3. The panel according to claim 1, wherein at least part of the at least one top coating layer comprises a plurality of microstructures, wherein the at least one top coating layer has a peak to valley height (Rz) of at least 10 μm, a surface roughness (Ra) of at least 1 μm, a mean of the third maximum peak-to-valley heights (R3z) of at least 5 μm, and/or a maximum height of the third highest peak to the third lowest valley (R3y) of least 5 μm.

4. The panel according to claim 1, wherein the coefficient of friction (COF) of the at least one coating layer is at least 0.4 and/or wherein a pendulum slip resistance (PTV) of the at least one coating layer is at least 36 according to ISO BS 7976-2.

5. The panel according to claim 1, wherein the panel has a micro scratch resistance of at least MSR-B3 and/or a gloss retention performance of at least MSR-A2 when tested according to EN 16094 in combination with a mass of at least 16 N and at least 80 R.

6. The panel according to claim 1, wherein the panel has a surface scratch of at least 2500 g, when tested to ISO 1518.

7. The panel according to claim 1, wherein the at least one decorative surface is directly or indirectly attached to the at least one core layer or wherein the at least one decorative surface forms integral part of the at least one core layer.

8. The panel according to claim 1, wherein the sheen or gloss level of the second surface area is 2-3 Gu lower than the sheen or gloss level of the second surface area.

9. The panel according to claim 1, wherein the at least one decorative print is provided via digital printing, inkjet printing, rotogravure printing machine, electronic line shaft (ELS) rotogravure printing machine, automatic plastic printing machine, offset printing, flexography, and/or rotary printing press.

10. The panel according to claim 1, wherein the at least one coating layer comprises a surface adhesion layer and/or a sheen control coating layer, wherein the sheen control coating layer is at least partially exposed and has a sheen of 1-15 Gu.

11. The panel according to claim 10, wherein the surface adhesion layer and/or sheen control coating layer is the primer layer.

12. The panel according to claim 10, wherein the sheen control coating layer forms at least partially the second surface area.

13. The panel according to claim 1, wherein the at least one coating layer comprises at least one monomer selected from at least a crosslinking acrylate monomer, a polymerizable cyclic/aromatic acrylate monomer and/or a diluent acrylate monomer.

14. The panel according to claim 1, wherein the at least one coating layer comprises at least one oligomer selected from an acrylic oligomer and/or a polyurethane oligomer.

15. The panel according to claim 1, wherein the at least one coating layer comprises at least one photo-initiator in the range of 2 wt % to 10 wt % based on total weight of the coating formulation.

16. The panel according to claim 15, wherein the at least one photo-initiator comprises a radical photo-initiator and/or cationic photo-initiator chosen from the group of acrylate- or styrene-based formulations, methyl-2-benzoylbenzoate, 2-hydroxy-2-methyl-1-phenyl-1 propanone, benzyl dimethyl ketal, 1-hydroxy-cyclohexylphenyl-ketone, or methyl benzoyl formate, or other photo-initiator, or any combination thereof.

17. The panel according to claim 15, wherein the at least one photo-initiator is configured to react to light or ultraviolet (UV) light having a wavelength in the range of 108 to 395 nm.

18. A decorative floor panel or wall panel, comprising:
at least one core layer;
at least one decorative surface comprising at least one decorative print; and
at least one coating layer provided upon the decorative surface;
wherein the at least one coating layer comprises at least one primer layer and at least one top coating layer;
wherein the gloss or sheen level of the at least one top coating layer is at most 4 Gu; and
wherein the at least one decorative surface comprises a texture having a consistent gloss level over the entire texture.

19. The panel according to claim 18, wherein the texture is free of spots of an inconsistent gloss level.

20. The panel according to claim 18, wherein the at least one top coating layer comprises at most 0.5 wt % of matting agents.
